(19) United States
(12) Patent Application Publication
(10) Pub. No.: US 2007/0186962 A1
(43) Pub. Date: Aug. 16, 2007

(54) Portable, self-contained, bioremediation waste water treatment apparatus with integrated particulate removal

(75) Inventors: Raymond Niedzwiecki, Palo Alto, CA (US); Neil Bailer, Bridgeport, PA (US); Scott Eliason, Troutdale, OR (US)

Correspondence Address: BEYER WEAVER LLP, P.O. BOX 70250, OAKLAND, CA, 94612-0250, US

(73) Assignee: EZ Environmental Solutions Corporation, Menlo Park, CA (US)

(21) Appl. No.: 11/707,526

(22) Filed: Feb. 16, 2007

Related U.S. Application Data
(60) Provisional application No. 60/774,425, filed on Feb. 16, 2006.

(51) Int. Cl. B08B 3/04; B08B 3/00

(52) U.S. Cl. 134/104.2; 134/111; 134/109

(57) ABSTRACT

A closed-loop wash system is provided for use with a washing assembly that includes a collection basin and a self-contained, bioremediation treatment apparatus. A housing assembly defines a plurality of chambers in series flow communication from an upstream collection chamber to a downstream clean wash fluid chamber. A central media chamber is included in upstream flow communication with the upstream collection chamber and in downstream flow communication with the downstream clean wash fluid chamber. An array of media housing microbes is disposed in the media chamber. The treatment apparatus includes a diffusion assembly configured to aerate the washing fluid contained in selected chambers. A first circulation system continuously circulates flow through the bioremediation system, while an independent second circulation system continuously circulates flow from the collection basin to the bioremediation treatment apparatus, and then back into the collection basin. The first circulation system, the second circulation system and the diffusion assembly cooperate to substantially evenly distribute the microbe population and the oxygenated clean wash fluid throughout the wash system.

### RELATED APPLICATION DATA

The present application claims priority under 35 U.S.C. §119 to U.S. Provisional Application Ser. No. 60/774,425, naming Niedzwiecki et al. as inventors, filed Feb. 16, 2006, and entitled PORTABLE, SELF-CONTAINED, BIOREMEDIATION WASTE WATER TREATMENT APPARATUS WITH INTEGRATED PARTICULATE REMOVAL, the entirety of which is incorporated herein by reference for all purposes.

### FIELD OF THE INVENTION

The present invention relates generally to methods and apparatus for use in the removal of organic and particulate matter from a waste stream. More particularly, the present invention relates to methods and apparatus to process waste water occurring from cleaning processes.

### BACKGROUND OF THE INVENTION

Contamination of the environment by man-made substances has been considered a serious problem for a long time. Recently, concern about contamination of earth, air, and groundwater by oil, toxic chemicals, and other hazardous wastes has expanded beyond large-scale industry to encompass the activities of many small businesses including automobile service stations, and many others. Both government regulations and social outcry have placed tremendous pressure on these businesses to avoid discharging hazardous wastes into the environment in the course of ordinary business activities.

Many businesses partake in activities that are likely to produce waste that may be harmful to the environment. For example, in an automobile service station, washing or steam-cleaning auto parts, e.g., an automobile engine, often causes engine oil, gasoline, and other chemicals to enter a storm drain system, or other waterways, thereby leading to the potential contamination of groundwater. In addition, those who service remotely located equipment generally have a need to wash the equipment without discharging hazardous waste into the environment. By way of example, persons who service roof-mounted air conditioners that contain lubricating petrochemicals, trapped pollutants, or other chemicals are not permitted to wash the equipment in a manner that could cause chemicals to run off the roof and into the surrounding environment. These environmental concerns also apply to the cleaning of equipment, materials and tools; the cleaning of rental equipment is one of many industries that must prevent hazardous material from being discharged into the environment.

For example, in the tool rental industry, vendors must provide its customers with a wide range of products ranging from hand tools to 80,000 pound excavators. When this equipment is returned to the rental agency, the rental agency will clean the equipment prior to the next customer using the equipment. The cleaning process is generally accomplished with a stream of water that may be pressurized from 25 psi to 1,500 psi or more. The waste stream thus created must be processed to prevent contamination from reaching the environment. The present invention processes the waste stream to remove the organic and particulate matter therein.

In another example, industrial-sized lawn mowers such at those applied in golf course maintenance, must be periodically cleaned. This cleaning process is also similarly accomplished using a wash bay and a stream of wash fluid that may be heated and pressurized from 25 psi to 1,500 psi. The organic and particulate matter run-off waste for this application, however, is primarily composed of hydrocarbons, pesticides, fertilizer compounds and chlorophyll. Similarly, this waste stream must also be processed to prevent contamination from reaching the environment.

### SUMMARY OF THE INVENTION

The present invention provides a closed-loop wash system for use with a washing assembly. The system includes a collection basin adapted to collect run-off washing fluid from the washing assembly, and a self-contained, bioremediation treatment apparatus. A housing assembly is included that defines a plurality of chambers in series flow communication from an upstream collection chamber to a downstream clean wash fluid chamber. The housing assembly further defines a media chamber in upstream flow communication with the upstream collection chamber and in downstream flow communication with the downstream clean wash fluid chamber. An array of media houses microbes on exposed surfaces thereof, and is disposed in the media chamber such that a substantial portion of washing fluid flowing from the upstream collection chamber to the media chamber flows through the array of media. The bioremediation wash fluid treatment system further includes a diffusion assembly that is in direct flow communication with at least one of the upstream collection chamber and the clean wash fluid chamber. The diffusion assembly is configured to aerate the washing fluid contained therein.

A first circulation system is provided that includes a flow inlet in flow communication with the clean wash fluid chamber and a flow outlet in flow communication with the upstream collection chamber. This system is configured to circulate clean washing fluid from the downstream clean wash fluid chamber into the upstream collection chamber. Hence, aerated clean washing fluid is circulated through the bioremediation wash fluid treatment system, from the upstream collection chamber through the media chamber and on back to the clean wash fluid chamber.

A second circulation system is also provided that includes a flow inlet from the media chamber that draws wash fluid at a location downstream from the array of media. This flow inlet of wash fluid, which is laden with fresh microbes, is directed into the collection basin to directly mix with the collected run-off washing fluid therein. A flow outlet is provided from the collection basin back into the housing assembly upstream from the clean wash fluid chamber.

By mixing the cleansed, aerated, microbe laden wash fluid with the contaminated run-off wash fluid directly in the collection basin, cleansing can commence earlier in the progression. Accordingly, systematic cleansing of the contaminants is performed more efficiently. Moreover, the continuous dual circulation systems, together with the diffusion assembly distribute the cleaned, aerated wash fluid substantially more evenly about the media which enhances the growth of microbes on the media.

In one specific embodiment, the housing assembly further includes a first baffle wall that cooperates with the housing assembly and first end wall to define the upstream collection chamber. A second baffle wall cooperates with the housing assembly and the first baffle wall to define the media chamber. A third baffle wall upstands from the floor and terminates below an upper edge of the housing assembly, forming an over weir. The third baffle wall and the housing assembly cooperate to define the clean wash fluid chamber oriented downstream from the media chamber.

In one specific embodiment, the housing assembly further defines a central clarifying chamber positioned between the media chamber and the clean wash fluid chamber. A fourth baffle wall is configured to downstand into the clarifying chamber and terminates above the floor of the housing assembly to form an under weir. The flow outlet from the second circulation system, thus, may terminate into the clarifying chamber, between the second baffle wall and the fourth baffle wall.

Moreover, a fifth baffle wall extends into the housing assembly between the second baffle wall and the fourth baffle wall. This fifth baffle wall defines portions of both the media chamber and the clarifying chamber, and further separates each other from one another.

In another arrangement, the first baffle wall is configured to upstand from the floor of the housing assembly, and terminates below the upper edge of the housing assembly to form an over weir. The adjacent second baffle wall is configured to downstand into the medial chamber and terminates above the floor of the housing assembly to form an under weir.

In yet another embodiment, the diffusion assembly includes a respective diffusion element oriented proximate the bottom of both the upstream collection chamber and the clean wash fluid chamber. A heater assembly can be disposed in either the clean wash fluid chamber or the upstream collection chamber, or both, to heat the wash fluid in that respective chamber.

### BRIEF DESCRIPTION OF THE DRAWINGS

The method and assembly of the present invention has other objects and features of advantage which will be more readily apparent from the following description of the Detailed Description of the Embodiments and the appended claims, when taken in conjunction with the accompanying drawing, in which:

FIG. 1 is a schematic side elevation view of a portable, self-contained, bioremediation waste water treatment apparatus with integrated particulate removal designed in accordance with the present invention.

FIG. 2 is a schematic top plan view of the portable, self-contained, bioremediation waste water treatment apparatus of FIG. 1.

FIG. 3 is a top perspective photograph of a representative wash platform that the treatment apparatus of FIG. 1 may work in conjunction therewith.

### DETAILED DESCRIPTION OF THE EMBODIMENTS

While the present invention will be described with reference to a specific embodiment, the description is illustrative of the invention and is not to be construed as limiting the invention. Various modifications to the present invention can be made to the preferred embodiments by those skilled in the art without departing from the true spirit and scope of the invention as defined by the appended claims. It will be noted here that for a better understanding, like components are designated by like reference numerals throughout the various figures.

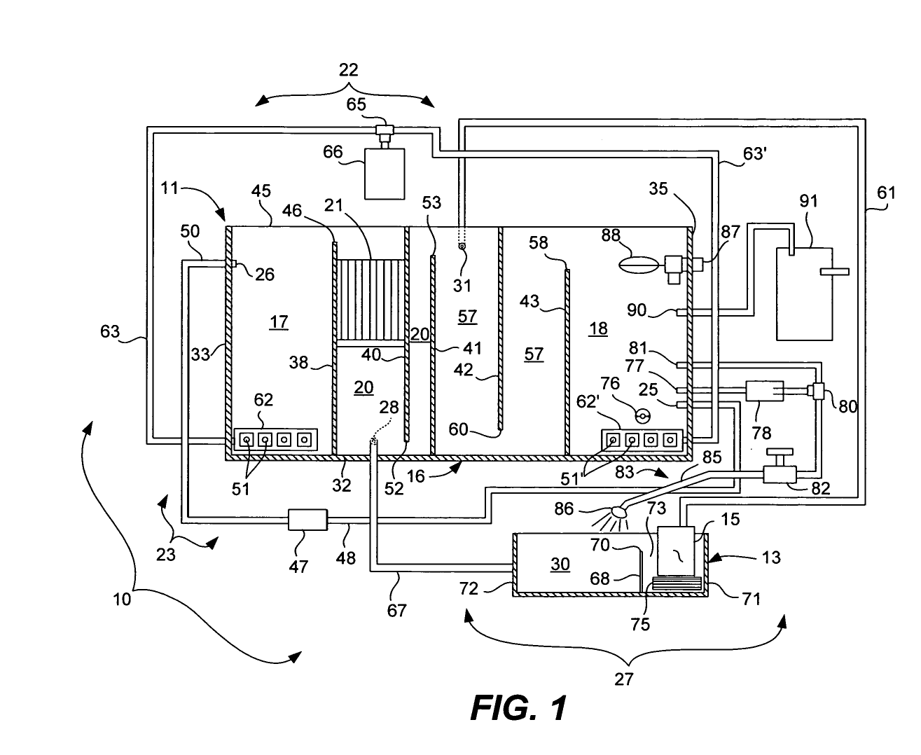

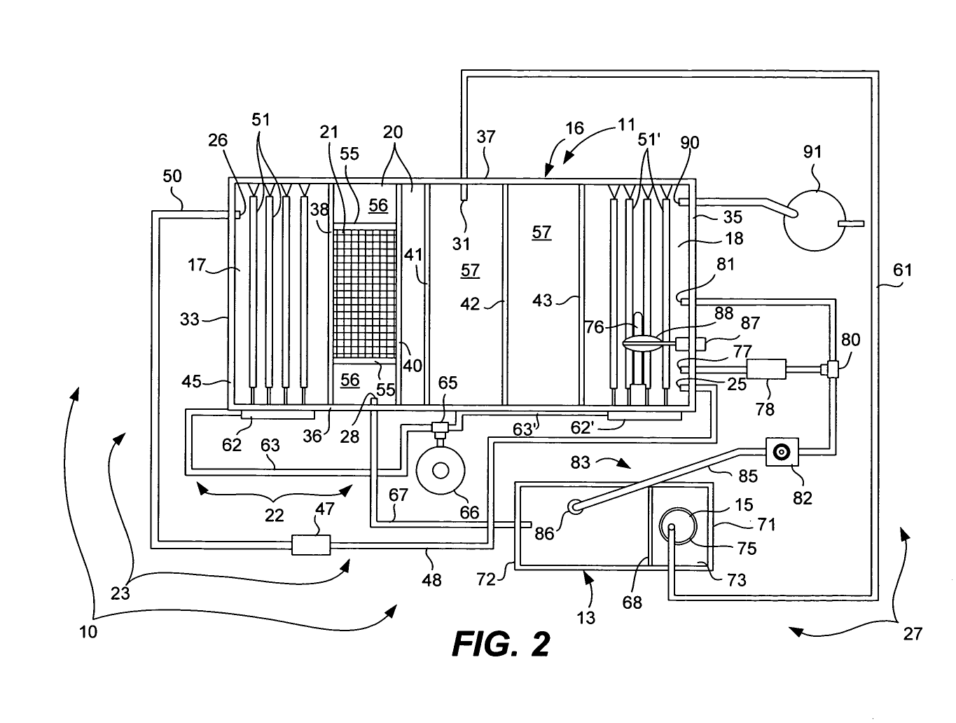

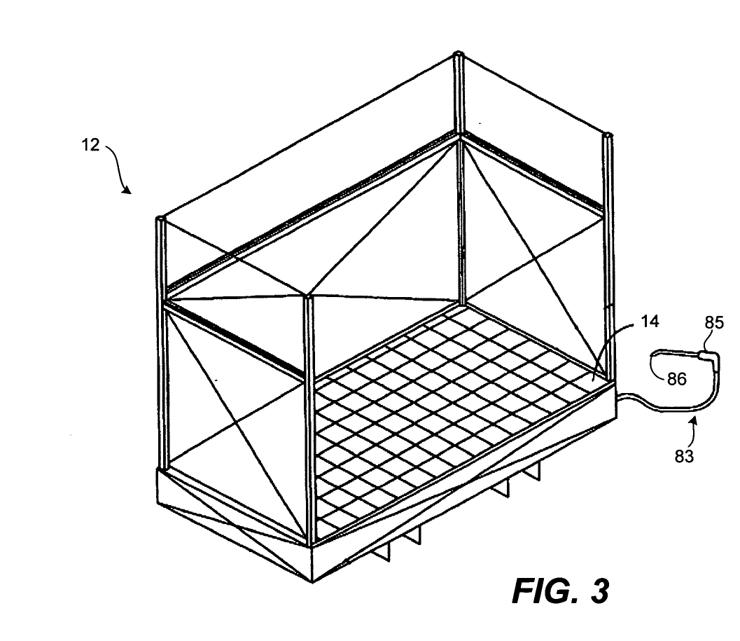

Attention is now directed to FIGS. 1 and 2 where a portable, closed-loop, wash system, generally designated 10, is illustrated with an integrated particulate removal system for waste water treatment, via a self-contained, bioremediation, waste water treatment apparatus 11. This unit is particularly suitable for use with a closed-loop pressure washer system 12 (FIG. 3) that collects the run-off water for subsequent processing and reuse through the pressure washer. For example, after the contaminated run-off water is collected from the wash platform, it is diverted into a collection basin 13 typically disposed below or adjacent the wash platform 14. A transfer pump 15 in the collection basin 13, as will be described in greater detail below, is operated to pump the collected and contaminated run-off wash fluids, together with its contaminants, into the bioremediation treatment apparatus 11 for wash fluid processing.

This self-contained, bioremediation treatment apparatus 11 includes a housing assembly 16 that defines a plurality of adjacent chambers in series flow communication with one another from an upstream region to a downstream region thereof. In the upstream-most region of the housing assembly 16 is an upstream collection chamber 17, and at a downstream-most region is a downstream clean wash fluid chamber 18. Disposed between these chambers 17, 18 is a media chamber 20 that is in upstream flow communication with the upstream collection chamber 17, and further in downstream flow communication with the downstream clean wash fluid chamber 18.

FIG. 1 best illustrates that an array of media 21 is disposed in the media chamber 20 that houses or contains microbes (or other bacteria) on exposed surfaces thereof. The array of media 21 is disposed in the media chamber 20 such that a substantial portion of washing fluid flowing from the upstream collection chamber 17 to the media chamber 20 flows through the array of media 21. As will be described below, the array of media 21 is selected as a one-way flow, self cleaning media. A diffusion assembly, generally designated 22, is included that is in direct flow communication with at least one of the upstream collection chamber 17 and the clean wash fluid chamber 18 to aerate the washing fluid contained therein.

The wash system further includes a first circulation system 23 having a flow inlet 25 in flow communication with the clean wash fluid chamber 18 and a flow outlet 26 in flow communication with the upstream collection chamber 17. As the first circulation system operates, the clean washing fluid is driven from the downstream clean wash fluid chamber 18, via flow inlet 25, into the upstream collection chamber, via flow outlet 26, in a manner causing the aerated clean washing fluid (in either the clean wash fluid chamber or the collection chamber 17) to circulate through the bioremediation system. Hence, once the clean wash fluid is transferred from the clean wash fluid chamber 18 to the upstream collection chamber 17, via the first circulation system, it flows into the media chamber and substantially through the array of media 21, populating the clean wash fluid with the cleansing microbes. From the media chamber 20, the clean wash fluid flows downstream, eventually collecting in the clean wash fluid chamber 18 where it is collected for use or for recirculation throughout the bioremediation apparatus.

In accordance with the present invention, the wash system 10 includes a second circulation system, generally designated 27, that includes a flow inlet 28 from the media chamber 20, at a location downstream from the array of media 21, into the collection basin 13 to mix a portion of the microbe populated, clean wash fluid directly with the collected run-off washing fluid directly in a collection compartment 30 of the collection basin. The second circulation system 27 also includes a flow outlet 31, in flow communication with the housing assembly 16 and terminates at a location upstream from the clean wash fluid chamber 18.

Collectively, the first circulation system 23, the second circulation system 27 and the diffusion assembly 22 cooperate to substantially evenly distribute the microbe population and the oxygenated wash fluid throughout the system. This is advantageous in that for one, the growth of the microbes on the media is enhanced due to the even distribution of oxygenated wash fluid across the entire array of media. This system is also advantageous in that the microbe populated wash flow is at least partially directed right into the contaminated run-off washing fluid collected in the collection compartment 30 of the collection basin 13, as mentioned. The contaminated wash fluid can thus be attacked by the microbes directly at the contamination source, at least with respect to the closed loop wash system. Accordingly, systematic cleansing of the contaminants is performed more efficiently.

The housing assembly is generally rectangular-shaped having floor 32, a first end wall 33, an opposed second end wall 35, a front wall 36 and a rear wall 37, all of which upstand from the floor 32. Collectively, theses outer shell walls define the interior cavity of the treatment apparatus that is separated into the aforementioned chambers through a series of adjacent baffle walls, generally designated 38, 40, 41, 42 and 43. These baffle walls span and extend from the front wall 36 to the rear wall 37, and form a series of alternating over weirs and under weirs, as will be described henceforth, that divert and direct the flow of wash fluid contained in the treatment apparatus commencing with the upstream collection chamber 17 to the next adjacent media chamber 20, and on down to the end clean wash fluid chamber 18.

The bioremediation treatment apparatus 11 includes a first baffle wall 38 that cooperates with the housing assembly front wall 36, rear wall 37 and first end wall 33 to define the upstream collection chamber 17. Preferably, the first baffle wall upstands from the floor 32 of the housing assembly, and terminates at an upper baffle edge just below the upper edges 45 of the housing assembly, forming a collection over weir 46. This upper over weir edge of the collection chamber 17 is preferably substantially linear and substantially horizontal. It will be appreciated, however, that the upper over weir edge may be shaped (e.g., V-shaped or slanted) in a manner to direct flow through particular areas of the media chamber, relative to the array of media 21, should this be desirable. Further, while the collection over weir 46, formed between the first baffle wall 38 and the upper edge 45 of the housing assembly 16 is only about 1.0 inch, deeper over weirs can be formed.

The upstream collection chamber 17 functions as a depository of the clean, oxygenated, wash fluid that is transferred from the clean wash fluid chamber 18 to the collection chamber, via the first circulation system 23. This circulation system includes a first transfer pump 47 and inlet flow piping 48 (defining the flow inlet 25) in flow communication with the clean wash fluid chamber 18. The flow inlet 25 is preferably oriented proximate to the bottom of the clean wash fluid chamber 18 to draw the cleaned wash fluid therein. In contrast, the flow outlet 26 of the first circulation system 23 includes outlet flow piping 50 containing the flow outlet mounted to the first end wall 33, and an opposite end mounted to the outlet of the first transfer pump 47. The first transfer pump 47 is preferably provided by a Laing pump, suitable to transfer clean wash fluid from the clean wash fluid chamber 18 to the collection chamber 17 in the flow range of up to about 20 gpm. More preferably, the flow transfer of the first circulation system is the range of about 6.0 gpm.

As will be further described below, either the clean wash fluid chamber 18 or the upstream collection chamber 17 cooperates with the diffusion assembly 22 to aerate the clean wash fluid contained therein. In the preferred form, both the collection chamber 17 and the clean wash fluid chamber 18 contain diffusers 51, 51′ proximate the respective bottoms thereof, but both may operate independently or may be excluded from either chamber. The upstream collection chamber 17 generally functions as a secondary aeration chamber where the clean, oxygenated, wash fluid is transferred, via first transfer pump 47, from the clean wash fluid chamber 18 for reprocessing. When the water level in the upstream collection chamber 17 is less than about 1.0 inch from the upper edge 45 of the housing assembly 16 (i.e., corresponding to the collection over weir 46), the wash fluid will flow over the first baffle wall 38 and into the media chamber 20.

A second baffle wall 40 cooperates with the housing assembly 16 and the first baffle wall 38 to define an upstream portion of the media chamber 20 that supports the array of media 21. The second baffle wall 40 preferably downstands from the upper edge of the housing assembly, and terminates at a lower edge just above the floor 32, forming a media under weir 52. Such termination is in the range of about 14 inches to about 28 inches from the floor, and is preferably substantially horizontal and linear. The media chamber 20 is fully defined by another adjacent baffle wall (i.e., a fifth baffle wall 41) upstanding from the floor of the housing assembly 16, and terminating at an upper edge thereof that is oriented below the upper edge 45 of the housing assembly, forming a media over weir 53. Similar to the upper edge of the collection chamber 17, the upper edge (the media over weir 53) of the media chamber 20 is preferably substantially linear and substantially horizontal.

The entire media chamber 20, hence, is formed between the front wall 36, the rear wall 37, the first baffle wall 38, the second baffle wall 40 and the fifth baffle wall 41. The upstream end of the media chamber, thus, commences with the collection over weir 46 of the first baffle wall, and the downstream end thereof ends with the media over weir 53 of the fifth baffle wall 41.

Initially, as the cleaned and oxygenated wash fluid contained in the upstream collection chamber flows over the collection over weir 46, the flow is substantially directed through the array of media 21 that contains the microbes. When the fluid flows through the media, the aerated wash fluid provides oxygen to the microbes contained on the surfaces of the media, facilitating reproduction and growth of the microbes. This flow, however, also flushes some of the microbes from the surfaces of the media, populating the oxygenated wash fluid that is contained in media chamber 20 with microbes, downstream from the array of media 21. Such populated wash fluid is collected in the media chamber until it flows under the media under weir 52, and up and over the media over weir 53 thereof.

The media pack 21 is preferably plastic (made from PVC or polypropylene) and is configured to attract microbes and assists in the colonization of the bioreactor. The media pack (array of media 21) is constructed from thin (0.020-0.040 inch thick) plastic sheets arranged at right angles to each other and forming vertical columns when installed in the treat apparatus 11. The surface area of the vertical columns is approximately 30 square feet for each cubic foot of media. The warm, oxygenated water from the upstream collection chamber 17 flows over the collection over weir 46 formed by the upper edge of first baffle wall 38 and into the media chamber 20. The array of media 21 is arranged to provide a vertical path for the oxygenated water to pass over the surface area of the media pack 21. Hence, in this media chamber 20, a single media pack 21 contains the fixed film media for the bacteria colonies to develop on and for the sloughing process of spent microbes.

One example of the array of media 21 includes the Accu Pac VF-3800 Media_Provided by Brentwood Industries. Such media may be self cleaning, depending upon the direction of flow therethrough. Thus, in accordance with the present invention, the array of media is disposed and oriented in the media chamber in such a manner that the flow of the aerated wash fluid through the array of media corresponds to the directional flow orientation of the media. This is advantageous in that the self-cleaning feature of the media is allowed to operate as designed.

As best viewed in FIG. 1, the media chamber 20 houses the array of media near the top of the chamber just downstream from the collection over weir 46 that contains bacteria selected for their ability to process organic compounds into carbon dioxide and water. This array of media is disposed in the media chamber such that a substantial portion of washing fluid flowing from the upstream collection chamber to the media chamber flows through the array of media.

One side of the array of media 21 is oriented substantially adjacent or in contact with one side of the first baffle wall 38, while an opposite side of the array is also oriented substantially adjacent or in contact with one side of the second baffle wall 40. Extending laterally across the first portion of the media chamber from first baffle wall 38 to the opposed side of the second baffle wall 40, is a pair of right angle support channels 55. These support channels 55, that are either removably mounted and/or are welded to the opposed first and second baffle walls 38, 40, function to support and position the array of media near the collection over weir 46 of the first baffle wall.

It will be appreciated that the array of media 21 need not extend fully across the transverse cross-sectional dimension of the chamber, as long as a significant portion of the wash fluid flowing over the over weir 46 passes through the media 21. Thus, as best illustrated in FIG. 2, the flow of wash fluid may pass through the front and rear end spaces 56, 56′ between the central array of media 21 and the respective front wall 36 and rear wall 37 in the first portion of the chamber. This space is beneficial in that periodic maintenance of the media may be more easily accomplished and a fluid flow path continues to exist in the event plugging of the media occurs from the non-performance of periodic maintenance.

In accordance with the present invention, the bioremediation treatment apparatus 11 also includes a clarifying chamber 57 disposed between the media chamber 20 and the clean wash fluid chamber 18. As best shown in FIG. 1, this chamber functions as a clarifying tank, and is formed between the front wall 36, the rear wall 37, the third baffle wall 43 and the fifth baffle wall 41. This clarifying chamber 57 is preferably a single stage clarifier that includes an under weir 60 defined by a fourth baffle wall 42, and is disposed between the third baffle wall 43 and the fifth baffle wall 41. Accordingly, this embodiment of the treatment apparatus 11 combines a biological reactor and a clarifier in a single, portable waste water treatment apparatus.

The fifth baffle wall 41 separates the media chamber 20 from the clarifying chamber 57. In a similar manner, the third baffle wall 43 separates the clarifying chamber from the clean wash fluid chamber 18. This wall 43 upstands from the floor of the housing assembly 16, and terminates at an upper edge that is oriented below the upper edge of the housing assembly, forming a clarifier over weir 58.

Similar to the upper edge (i.e., the collection over weir) of the collection chamber 17 and that of media chamber 20, the upper edge of the clarifying chamber 57 is preferably substantially linear and substantially horizontal. Moreover, it will be appreciated that the vertical orientation of the upper edge of the collection chamber 17 is higher than that of the media chamber, and similarly, the vertical orientation of the upper edge of the media chamber is higher than that of the clarifying chamber. Hence, this sequential tiered approach of the adjacent over weirs 46, 53 and 58 promotes the flow of wash fluid in the downstream direction from upstream collection chamber 17 toward the clean wash fluid chamber 18, when the first circulation system 23 is operating. In one specific example, collection over weir 46 of the first baffle wall 38 in the upstream collection chamber 17 is about 1.0 inch lower than the top upper edge 45 of the housing assembly 16 while the media over weir 53 the fifth baffle wall 41 of the media chamber 20 is about 2.0 inches lower than the upper edge 45 of the housing assembly 16. Finally, in this specific embodiment, the collection over weir 58 of the third baffle wall 43 is about 3 inches lower than the upper edge 45 of the housing assembly 16 such that the water cascades from chamber to chamber and prevents the fluid in the bioremediation apparatus 11 from flowing opposite to the direction intended in the design.

To form the first stage clarifier, the fourth baffle wall 42 extends downwardly from the upper edge of the housing assembly and into the clarifying chamber 57. This wall includes a lower edge that terminates above the floor 32, forming a clarifier under weir 60. Accordingly, as the flow outlet 31 of the second circulation system 27 deposits the run-off wash fluids directly into an upstream portion of the clarifying chamber 57, the under weir 60 formed by the fourth baffle wall 42 of the clarifying chamber traps all floating contamination and prevents its transfer to the clean wash fluid chamber 18 of the apparatus. Any remaining solids in the run-off waste fluid, in turn, are allowed to settle to the bottom of clarifying chamber.

The vertical orientation of the clarifier under weir 60 is preferably higher than that of the media under weir 52. Such vertical orientation should be sufficient to accommodate the build up of the deposited solids at the bottom thereof. After flowing under the lower edge of the clarifier under weir 60 of the fourth baffle wall 42, the clarified wash fluid flows up and over the clarifier over weir 58 of the third baffle wall 43 that separates clarifying chamber 57 from the clean wash fluid chamber 18.

Referring now to FIG. 2, the clean wash fluid chamber 18 is formed between the front wall 36 and the rear wall 37, and is further defined by the third baffle wall 43 and the opposed second end wall 35 of housing assembly 16. Hence, after clarification of the wash fluid in the clarifying chamber 57, the clarified fluid flows over a clarifier over weir 58 of the third baffle wall 43, where it is preferably initially aerated through the respective diffusers 51′ disposed at the bottom of the clean wash fluid chamber 18.

In the preferred embodiment, the full aeration of the wash fluid is performed in two independent chambers, and in series, prior to passing through the array of media 21 in the media chamber. In that manner, a sufficient transfer of oxygen to the wash fluid can be performed. However, since the first circulation system 23 fluidly couples the clean wash fluid chamber to the upstream collection chamber 17, the adjacent chambers (i.e., in terms of flow) are actually at the upstream-most chamber of the bioremediation treatment apparatus 11 and the downstream-most chamber thereof.

FIG. 2 best represents that the diffusion assembly 22 includes a series of respective diffuser 51, 51′ extending across both the clean wash fluid chamber 18 and the upstream collection chamber 17 proximate to the housing assembly floor. These diffusers 51, 51′ provide a flexible membrane over a large diameter pipe. Low pressure air is injected between the top surface of the pipe and the bottom surface of the flexible membrane. The flexible membrane has been processed to contain a plurality of fine slits that when subjected to a low pressure supply of air, will open and diffuse the air into the water as fine bubbles (approximately 1 mm in diameter) that filter through the wash fluids contained in the respective chambers. It will be appreciated that when the supply of pressurized air is removed, the slits in the membrane will close and prevent the backflow of water into the diffuser and manifold. The filtering facilitates the transfer of oxygen to the clean wash fluid when approximately 4-5 scfm (standard cubic feet per minute) of low pressure air is supplied to each diffuser 51′.

Each diffuser 51, 51′ of the diffusion assembly 22 is connected to a respective manifold device 62, 62′, each of which is disposed and installed outside of the housing assembly 16 at their respective clean wash fluid chamber 18 and upstream collection chamber 17. Examples of such diffusers and manifold system include the Flex Air T-Series Model 00256 from Environmental Dynamics Incorporated. It will be appreciated that, depending upon the design, the manifold devices may be incorporated inside the housing assembly, as well as outside the housing assembly.

Conventional tubing or piping 63, 63′ connect the manifold devices 62, 62′ to a “tee” fitting 65, which in turn is connected to an air pump 66 of the diffusion assembly 22. As mentioned above, the diffusers 51, 51′ are selected to output tiny bubbles (e.g., about 1 mm Dia.) when approximately 4-5 scfm (standard cubic feet per minute) of low pressure air is supplied to by each diffuser. Accordingly, the air pump 66 is selected to output a total of approximately 50 scfm at 2.5 psi (pounds per square inch) of air.

In accordance with the present invention, the closed loop wash system 10 includes both a first circulation system 23 and a second circulation system 27 that operate continuously to efficiently cleanse the wash fluid contained in the system, as well as efficiently aerate the wash fluid to care, maintain and grow the population of the microbes of the array of media 21. Briefly, the first circulation system 23 (as above described) is the primary engine driving the recirculation through the bioremediation treatment apparatus 11 from the downstream clean wash fluid chamber 18 back to the upstream collection chamber 17, via first transfer pump 47, and then back to the clean wash fluid chamber. This pump is typically selected to transfer approximately 6.0 gpm from the clean wash fluid chamber 18 to the upstream collection chamber, but may be varied of course. Accordingly, the cleansed waste water may recycle through the treatment apparatus to promote further aeration, clarifying and microbe treatment.

The second circulation system, on the other hand, provides two main functions in addition to driving circulation about the overall system. The first function is to transfer the contaminated run-off wash fluid (or waste stream) collected in the collection basin 13 from the wash platform 14 to the bioremediation treatment apparatus 11 for cleansing the waste stream. The second function of the second circulation system 27 is to system deposit clean wash fluid, freshly populated with microbes from the media chamber, directly into the collected waste stream in the collection basin. This is advantageous in that the flow of microbes in oxygenated water is sent to collection compartment 30 to begin immediate treatment of the waste stream at the source of the contamination or the first collection point, increasing the overall cleansing efficiency of the system.

The second circulation system 27 includes the flow inlet 28 from the media chamber 20, at a location downstream from the array of media 21, into the collection basin 13 to mix a portion of the microbe populated, clean wash fluid directly with the collected run-off washing fluid collected in the collection compartment 30 of the collection basin. In one embodiment, the flow inlet 28 is comprised of tubing or inlet flow piping 67 in gravity flow relationship with the collection basin 13. Such inlet flow piping 67 allows microbes in warm, oxygenated water to flow directly into collection basin 13 at a rate from about 4 gpm (gallons per minute) to about 10 gpm. A pump device (not shown), in the alternative, may be incorporated inline with the inlet flow piping 67, as well, without departing from the true spirit and nature of the present invention.

In accordance with the present invention, the flow inlet 28 is oriented downstream from the array of media 21. In this manner, clean, freshly microbe populated wash fluid can be flowed directly into, and intermix with, the contaminated wash fluid in the collection compartment 30 of the collection basin. As shown in FIG. 1, this flow inlet 28 is oriented proximate to the bottom of the media chamber 20, but not so low that sediments collected at the bottom thereof (since this is an under weir 52) are drawn into this input. Preferably, hence, the flow inlet is positioned about 18 inches above the housing floor 32. As will be described, however, in other configurations, the placement of the flow inlet 28 may be repositioned vertically upward in an effort to achieve a better overall head pressure balance for the entire system. That is, it is important to match the flow rate of the wash fluid into the collection basin 13, through the flow inlet 28, to that flowing out of the collection basin, through the flow outlet 31. Hence, depending upon the specific configuration, as will be described, the flow inlet 28 can be vertically positioned along the media chamber anywhere from about 18 inches above the floor 32 to about 4 inches from the upper edge 45 of the housing assembly.

In contrast, the flow outlet 31 of the second circulation system is applied to deposit the collected run-off that is intermixed with the clean, oxygenated, microbe wash fluid back into the bioremediation treatment apparatus 11. The flow outlet 31 is preferably oriented to output the collected run-off wash fluid into the housing assembly at an orientation upstream from the upstream clean wash fluid chamber 18. In this manner, the freshly deposited contaminated wash fluid can commence the initial clarification process before being recycled through the treatment apparatus.

FIGS. 1 and 2 best illustrate that the waste stream enters the clarifying chamber 57 between the fourth baffle wall 42 and the fifth baffle wall 41. The vertical position of the flow outlet 31 is in the upper region of the upstream portion of the clarifying chamber 57. Preferably, however, the flow outlet is not positioned lower than the clarifier over weir 58 at the downstream portion so that the flow of the wash fluid from the flow outlet 31 is not under wash fluid level contained in the clarifying chamber. Thus, the vertical orientation is at least above the clarifier over weir 58, and more preferably at or above the vertical orientation of the media over weir 53.

The waste stream that enters clarifying chamber 57 through the flow outlet 31 is actually undergoing additional cleansing treatment. That is, the first direct treatment of the contaminated wash fluid occurs directly in run-off collection compartment 30 of the collection basin through intermixing with the microbes and oxygenated wash fluid, via the flow inlet 28 of the second circulation system. The direct treatment thus occurs when the intermixed waste stream is transferred, via the second transfer pump 15, into the clarifying chamber 57 where the partially treated wash fluid again intermixes with the microbes and oxygenated wash fluid flowing over the media over weir 53.

Again, conventional tubing or outlet flow piping 61 fluidly couples the flow outlet 31 to the second transfer pump 15 disposed in the collection basin 13. The second transfer pump 15 is selected to transfer the contaminated wash fluid from the collection basin to the bioremediation treatment apparatus at a rate of about 30-40 gpm. An example of such a pump is the sump pump, model #6E series Eliminator by Little Giant Pump Co.

Referring back to the collection basin 13, a run-off collection compartment 30 is formed where the contaminated run-off wash fluid is first collected from a wash platform 14 (as shown in FIG. 3 for example) for further processing, and where used or contaminated oils and paint may be introduced to collection basin 13 irrespective of the washing operation. The collection basin 13, in one specific embodiment, may be a U-shaped compartment with end walls that are sealed to contain the waste stream within collection basin 13 (similar to those described in U.S. Pat. Nos. 6,120,614 and 6,402,855, both to Damron et al., and which are incorporated by reference herein in their entirety.

By way of example, a partition wall 68 may be included that forms an over weir 70 spaced from the right end wall 71 of collection basin 13, forming a fluid reservoir 91 where a second transfer pump 15 is disposed. In one specific configuration, this distance is about 12-24 inches from the right end wall. The collection compartment 30 of collection basin 13 is located between the left end wall 72 and the partition wall 68. This collection compartment 30 captures the run-off wash fluid and provides a vehicle for the settling of solid particulates at the bottom of the compartment. Additional waste stream contaminants such as oil, gasoline and fertilizer that have a specific gravity of less than 1.0 will float on the surface of the water introduced into collection basin 13 from both the media chamber 20 and the clean wash fluid chamber 18. These floating contaminants will flow over the over weir 70 in collection basin 13 and into a fluid reservoir 73 of collection basin 13 that contains a second transfer pump 15.

The collection basin 13 contains a perforated stainless steel pump standoff ring 75 about 6-10 inches in diameter and about 2-5 inches in height that is permanently affixed to the bottom surface of collection basin 13. The ring 75 supports the second transfer pump 15 whose inlet is less than about 1 inch above the top of the stainless steel pump standoff ring 75. The second transfer pump 15 transfers fluid directly to the clarifying chamber 57 of the treatment apparatus 11 where additional settling of particulates occurs in this clarifying portion. Additionally, any emulsified oils or other organic contaminants are combined with oxygenated, microbe enriched wash fluid from the media chamber 20 of the bioremediation treatment apparatus 11.

The ideal conditions that promote microbe growth are 1) a water temperature of 85° F.; 2) dissolved oxygen in the water; 3) and a food source. As above-indicated, the series of diffusers 51, 51′ are connected to respective manifolds 62, 62′ of the diffusion assembly 22 to oxygenate the cleaned wash fluid contained respectively therein. To heat the wash fluid, one or more heating element 76 are disposed in the chambers containing the aerated clean wash fluid prior to passing through the array of media 21 contained in the media chamber 20.

In the preferred embodiment, the heating element is placed in the downstream clean wash fluid chamber 18, just above the diffusers 51′. The clean wash fluid in this chamber 18, hence, is heated, and then transferred to the upstream collection chamber 17 where it is oxygenated, and pass over the collection over weir 46 and through the array of media. A temperature probe (not shown) is located in the media chamber 20 just past the array of media to measure the wash fluid temperature passing through the array.

In one specific embodiment, the heating element is provided by a 6,000_watt heating probe, model #RWSS-26018E2TIB by Glo-Quartz Electric Heater Company, Inc. It will further be appreciated that the heating element may be contained in the upstream collection chamber 17, as well as any other chamber without departing from the true spirit and nature of the present invention.

An inlet 77 from the clean wash fluid chamber 18 is connected to the inlet of a magnetically-coupled centrifugal pump 78. In turn, the outlet of this pump 78 is connected to a “tee” fitting 80. One end of the tee 80 returns to a flow inlet 81 in the clean wash fluid chamber 18 and serves as a bypass-line in the event that the water in the clean wash fluid chamber 18 is not being used as a cleaning agent.

The other side of the “tee” 80 is connected to a valve 82 that supplies the clean wash fluid to a pressure pump (not shown) of a pressure washer for cleaning operations. The outlet of the pressure pump may be fluidly coupled to a conventional spray pressure washing apparatus 83 to pressure wash the object using a conventional pressure wand or gun 85 and a compatible spray nozzle 86 (FIGS. 1 and 2). The water so used for cleaning is oxygenated by the diffusers 51′ in the clean wash fluid chamber 18 and provides additional oxygen to the microbes deposited in collection basin 13 when the magnetically coupled pump 78 is used for cleaning objects whose waste stream enters collection basin 13.

The pressure pump can be provided by any conventional high-pressure pump assembly, and is preferably capable of delivering a variable pressure for a selective pressure spray application. One such conventional pressure pump, for example, is that provided by WANNER, Model No. MD3EABJSSECA, which is capable of providing a low-pressure spray in the range of about 50 psi and a high-pressure spray in the range of about 3000 psi.

In one specific embodiment, a mechanically operated water inlet valve 87 is disposed in the second end wall 35 of the clean wash fluid chamber 18 to maintain the minimum operating water level throughout the system. A conventional level detector device 88 may be coupled thereto for automated water level operation.

An additional flow outlet 90 in clean wash fluid chamber 18 is connected to a secondary storage device 91 having a capacity from 50-200 gallons to temporarily store excess processed water before discharge for landscape irrigation or to sewer. Moreover, in applications containing a high solids run-off, a multi-stage clarifier device (not shown) may be incorporated inline in the outlet flow piping 61 of the second circulation system 27 between the collection basin 13 and the bioremediation treatment apparatus 11. This multi-stage clarifier, hence, is capable of removing a significant portion of the high solids passed through the second transfer pump 15 before reaching the bioremediation treatment apparatus. An example of such a clarifier device is disclosed in U.S. patent application Ser. No. 10/827,120, to George Hay, et al., incorporated by reference herein in its entirety.

In these applications, the flow inlet 28 from the media chamber 20 is oriented proximate to the top of the media chamber 20, as opposed to proximate to the housing floor 32 in the previous embodiments. As mentioned, the flow inlet 28 is ideally vertically positioned at an orientation that achieves the best overall head-pressure balance of the collective system. Accordingly, when an additional clarifier unit is positioned in-line with the outlet flow piping 61, it is important to match the head pressure of the media chamber with that of the clarifier unit so that the wash fluid flow through the flow inlet 28 is substantially the same as the wash fluid flow through the additional clarifier unit. For example, by repositioning the flow inlet 28 near the top of the housing upper edge 45 (e.g., about 4 inches below the upper edge), albeit below the wash fluid level in the media chamber 20, a better overall head pressure balance of the collective system is achieved.

While this invention has been described in terms of several preferred embodiments, there are alterations, permutations, and equivalents that fall within the scope of this invention. It is therefore intended that the following appended claims be interpreted as including all such alterations, permutations, and equivalents as fall within the true spirit and scope of the present invention.

What is claimed is:

1. A closed-loop wash system for use with a washing assembly comprising:
a collection basin adapted to collect run-off washing fluid from the washing assembly;
a self-contained, bioremediation treatment apparatus having
a housing assembly that defines a plurality of chambers in series flow communication from an upstream collection chamber to a downstream clean wash fluid chamber, said housing assembly further defining a media chamber in upstream flow communication with the upstream collection chamber and in downstream flow communication with the downstream clean wash fluid chamber,
an array of media housing microbes on exposed surfaces thereof, said array of media being disposed in said media chamber such that a substantial portion of washing fluid flowing from the upstream collection chamber to the media chamber flows through the array of media, and
a diffusion assembly in direct flow communication with at least one of the upstream collection chamber and the clean wash fluid chamber, and configured to aerate the washing fluid contained therein;
a first circulation system having a flow inlet in flow communication with the clean wash fluid chamber and a flow outlet in flow communication with the upstream collection chamber to circulate clean washing fluid from the downstream clean wash fluid chamber into the upstream collection chamber, and in a manner circulating aerated clean washing fluid through the bioremediation system, from the upstream collection chamber through the media chamber and on back to the clean wash fluid chamber; and
a second circulation system including a flow inlet from the media chamber, downstream from the array of media, into the collection basin to mix with the collect run-off washing fluid, and a flow outlet from the collection basin into the housing assembly upstream from the clean wash fluid chamber,
wherein said first circulation system, said second circulation system and the diffusion assembly cooperate to substantially evenly distribute the microbe population and the aerated wash fluid throughout the wash system.

2. The wash system as defined in claim 1, wherein
said housing assembly includes a floor, a front wall, an opposed rear wall, a first end wall and an opposed second end wall, each end wall extending from the front wall to the opposed rear wall;

3. The wash system as defined in claim 2, wherein
said bioremediation treatment apparatus includes
a first baffle wall that cooperates with said housing assembly and first end wall to define said upstream collection chamber;
a second baffle wall that cooperates with said housing assembly and said first baffle wall to define said media chamber in downstream communication flow with the upstream collection chamber, and
a third baffle wall upstanding from said floor and terminating below an upper edge of said housing assembly to form an over weir, said third baffle wall and said housing assembly cooperating to define said clean wash fluid chamber oriented downstream from said media chamber.

4. The wash system as defined in claim 3, further including:
said bioremediation treatment apparatus further defines a clarifying chamber positioned between the media chamber and the clean wash fluid chamber.

5. The wash system as defined in claim 4, wherein
said bioremediation treatment apparatus further defines a fourth baffle wall configured to downstand into the clarifying chamber and terminates above the floor of said housing assembly to form an under weir.

6. The wash system as defined in claim 5, wherein
said flow outlet from the second circulation system terminates into said clarifying chamber, between the second baffle wall and the fourth baffle wall.

7. The wash system as defined in claim 5, wherein
said bioremediation treatment apparatus further defines a fifth baffle wall extending into the housing assembly between the second baffle wall and the fourth baffle wall, said fifth baffle wall defining portions of both the media chamber and the clarifying chamber, and separating each other from one another.

8. The wash system as defined in claim 7, wherein
said first baffle wall is configured to upstand from the floor of said housing assembly, and terminates below said upper edge of said housing assembly to form an over weir, and
said second baffle wall is configured to downstand into the medial chamber and terminates above the floor of said housing assembly to form an under weir.

9. The wash system as defined in claim 1, wherein
said diffusion assembly includes a respective diffusion element oriented proximate the bottom of both the upstream collection chamber and the clean wash fluid chamber.

10. The wash system as defined in claim 1, further including:
a heater assembly configured to heat the wash fluid in at least one of the clean wash fluid chamber and the upstream collection chamber.

11. The wash system as defined in claim 1, further including:
an independent clarifying assembly positioned in the flow outlet of the second circulation system in-line between the collection basin and the housing assembly.

12. The wash system as defined in claim 1, wherein
said flow inlet from the media chamber into the collection basin, in said second circulation system, is by way of gravity flow.

13. The wash system as defined in claim 1, wherein
said first circulation system includes a pump device disposed between said flow inlet from the clean wash fluid chamber and said flow outlet from the upstream collection chamber.

14. A self-contained, continuous recirculation, bioremediation wash fluid treatment system for use with a washing assembly cleansed washing fluid from said bioremediation wash fluid treatment system, said system comprising:
a collection basin adapted to collect run-off washing fluid from the washing assembly;
a housing assembly having a floor, a front wall, an opposed rear wall, a first end wall and an opposed second end wall, each end wall extending from the front wall to the opposed rear wall;
a first baffle wall cooperates with said housing assembly and first end wall to define an upstream collection chamber;
a second baffle wall cooperates with said housing assembly and said first baffle wall to define a media chamber in downstream communication flow with the upstream collection chamber, said media chamber housing an array of media containing microbes, on exposed surfaces thereof, said array of media being disposed in said media chamber such that a substantial portion of washing fluid flowing from the upstream collection chamber to the media chamber flows through the array of media;
a third baffle wall upstanding from said floor and terminating below an upper edge of said housing assembly to form an over weir, said third baffle wall and said housing assembly cooperating to define a clean wash fluid chamber oriented downstream from said media chamber;
a diffusion assembly in direct flow communication with at least one of the upstream collection chamber and the clean wash fluid chamber, and configured to aerate the washing fluid contained therein; and
a first circulation system having a flow inlet in flow communication with the clean wash fluid chamber and a flow outlet in flow communication with the upstream collection chamber to circulate clean washing fluid from the downstream clean wash fluid chamber into the upstream collection chamber, and in a manner circulating aerated clean washing fluid, through the bioremediation system, from the upstream collection chamber through the media chamber and on back to the clean wash fluid chamber; and
a second circulation system including a flow inlet from the media chamber, downstream from the media array of media, into the collection basin to mix with the collect run-off washing fluid, and a flow outlet from the collection basin into the housing assembly upstream from the clean wash fluid chamber,
wherein said first circulation system, said second circulation system and the diffusion assembly cooperate to substantially evenly distribute the microbe population and aerated wash fluid throughout the distribution.

15. The bioremediation wash fluid treatment system as defined in claim 14, further including:
said housing assembly further defines a clarifying chamber positioned between the media chamber and the clean wash fluid chamber.

16. The bioremediation wash fluid treatment system as defined in claim 15, further including:
a fourth baffle wall is configured to downstand into the clarifying chamber and terminates above the floor of said housing assembly to form an under weir.

17. The bioremediation wash fluid treatment system as defined in claim 16, wherein
said flow outlet from the second circulation system terminates into said clarifying chamber, between the second baffle wall and the fourth baffle wall.

18. The bioremediation wash fluid treatment system as defined in claim 16, further including:
a fifth baffle wall extending into the housing assembly between the second baffle wall and the fourth baffle wall, said fifth baffle wall defining portions of both the media chamber and the clarifying chamber, and separating each other from one another.

19. The bioremediation wash fluid treatment system as defined in claim 18, wherein
said first baffle wall is configured to upstand from the floor of said housing assembly, and terminates below said upper edge of said housing assembly to form an over weir, and
said second baffle wall is configured to downstand into the medial chamber and terminates above the floor of said housing assembly to form an under weir.

20. The bioremediation wash fluid treatment system as defined in claim 14, wherein
said flow inlet from the media chamber into the collection basin, in said second circulation system, is by way of gravity flow.
